(19) United States
(12) Patent Application Publication
(10) Pub. No.: US 2011/0076468 A1
(43) Pub. Date: Mar. 31, 2011

(54) Kit For Decorating An Article

(76) Inventor: Stacey Lee Singer, San Anselmo, CA (US)

(21) Appl. No.: 12/894,145

(22) Filed: Sep. 30, 2010

Related U.S. Application Data
(60) Provisional application No. 61/246,980, filed on Sep. 30, 2009.

(51) Int. Cl. B41M 5/00; B43K 1/00; B05D 5/00

(52) U.S. Cl. 428/195.1; 401/292; 427/256

(57) ABSTRACT

A decorating kit is provided to a user. The decorating kit comprises an article having a color that conceals color applied to the article, one or more designs applied on the article, and one or more coloring markers for coloring the designs on the article. The color of the article is a light absorbing color, which conceals color applied to the article. The article is, for example, clothing, an accessory, a pet product, etc. The designs are screened or attached onto the article. When the user colors the designs on the article using the coloring markers, the colors that inadvertently extend beyond the designs onto the article are not visible on the article. The user can therefore color the designs on the article without the colors that over-mark the designs, visible on the article. The decorating kit further comprises decorative elements for decorating the designs and the article.

### CROSS REFERENCE TO RELATED APPLICATIONS

This application claims the benefit of provisional patent application number 61/246980 titled “Article Decorating Kit”, filed on Sep. 30, 2009 in the United States Patent and Trademark Office.

The specification of the above referenced patent application is incorporated herein by reference in its entirety.

### BACKGROUND

Consumers often like to decorate an article, for example, clothing or other merchandise with a design, for example, an outline of an animal, an emblem, a logo, etc. and to color that design with their color preferences. One method for providing artwork on an article is to embed an outline of a design on the article and allow the user to color the design on the article within the outline of the design. However, coloring within the outline of the design and avoiding over-marking or coloring the material of the article with the design is a painstaking process and requires a lot of time and effort and it may still not be free from error.

Hence, there is a long felt but unresolved need for decorating an article with a design and for coloring the design with the consumers' color preferences without coloring the material of the article beyond the design.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and decorating kit disclosed herein addresses the above stated need for decorating an article with a design and for coloring the design on the article to suit the color preferences of a user, without coloring the material of the article beyond the design. The decorating kit disclosed herein enables a user to decorate an article in a precise and error free manner. The decorating kit disclosed herein comprises an article the material of which has a color that conceals color applied to the article, one or more designs applied on the article, and one or more coloring markers for coloring the designs on the article. The article is, for example, clothing, an accessory, leather shoes, a handbag, a pet product, etc. The color of the article is a color on which colors applied to the article are not visible on the article. For example, the color of the article is a dark color such as black that conceals colors, for example, green, blue, etc. applied to the article.

The color of the material of the article is selected so that colors applied by the coloring markers that inadvertently extend beyond the designs onto the article is concealed by the article and is therefore not visible on the article. In an embodiment, the color of the material of the article is dark, for example, black so that colors from the coloring markers that over-mark or extend beyond the designs are concealed and do not show on the black colored material of the article. In another embodiment, the color of the material of the article is a light color, which does not show lighter colors applied to the designs on the article using the coloring markers.

In another embodiment, the article is made of a material that allows erasing or wiping off the colors that over-mark or extend beyond the designs onto the article during coloring. In this embodiment, the article is coated with a layer of synthetic oil or a silicone spray; the designs are then embedded or applied onto the article. The colors applied to the designs that over-mark or extend beyond the designs onto the article are erased or washed out, for example, by a detergent wash.

In another embodiment, the article comprises one or more configurable layers comprising multiple designs. As used herein, “configurable layers” refers to layers of the article that can be configured by a user into any shape and style to reveal different designs on an inner surface and an outer surface of the layers of the article. The configurable layers enable the user to expose and color the designs applied on the configurable layers in multiple styles and colors.

The decorating kit disclosed herein further comprises multiple decorative elements, for example, ornaments, beads, glitter, etc. that can be attached to the designs and the article itself for decorating the designs applied on the article and the article itself. In another embodiment, the decorating kit disclosed herein further comprises a color chart with color codes for aiding the user to select colors for coloring the designs applied on the article. The color codes in the color chart indicate modes of changing an appearance of the designs applied on the article and an object enclosed by the article.

The designs applied to the article are of different shapes and sizes. In an embodiment, cut-away or peelable designs are provided in the decorating kit disclosed herein, where the cut-away or peelable designs are cut out from materials, for example, paper, cardboard, fabric, etc. and attached to the article. The designs are applied to the article, for example, by screening or by attaching the designs to the article. The designs are applied to the article, for example, by a screen printing technique, a heat transfer printing technique, etc. In an embodiment, the designs are applied on both the inner surface and the outer surface of the article to render the article decoratable on both the inner surface and the outer surface of the article.

A user applies color from the coloring markers to color the designs applied on the article. Each of the coloring markers comprises a color dissolved in a solvent, or a color suspended in a solvent. Each of the coloring markers produces a washable color or a permanent color on the designs applied on the article. The colors from the coloring markers that inadvertently extend beyond the designs onto the article are not visible on the article. The user can therefore color the designs on the article using the coloring markers, without the colors that over-mark the designs, visible on the article.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 exemplarily illustrates a decorating kit for decorating an article.

FIG. 2 exemplarily illustrates an article with designs applied on the article.

FIG. 3A exemplarily illustrates an article with designs applied on an outer surface of the article.

FIG. 3B exemplarily illustrates the article folded inside out to show designs applied on an inner surface of the article.

FIG. 3C exemplarily illustrates the article configured to display the designs on the inner surface and the outer surface of the article.

FIG. 4 exemplarily illustrates an embodiment where an article comprises configurable layers that are selectively configured to display the designs colored with the color preferences of a user on the inner surface and the outer surface of each of the configurable layers of the article.

FIGS. 5A-5B exemplarily illustrate an embodiment of the decorating kit comprising a color chart with color codes for aiding a user to select colors for coloring designs applied on the article.

FIG. 6 exemplarily illustrates a method for decorating an article.

### DETAILED DESCRIPTION OF THE INVENTION

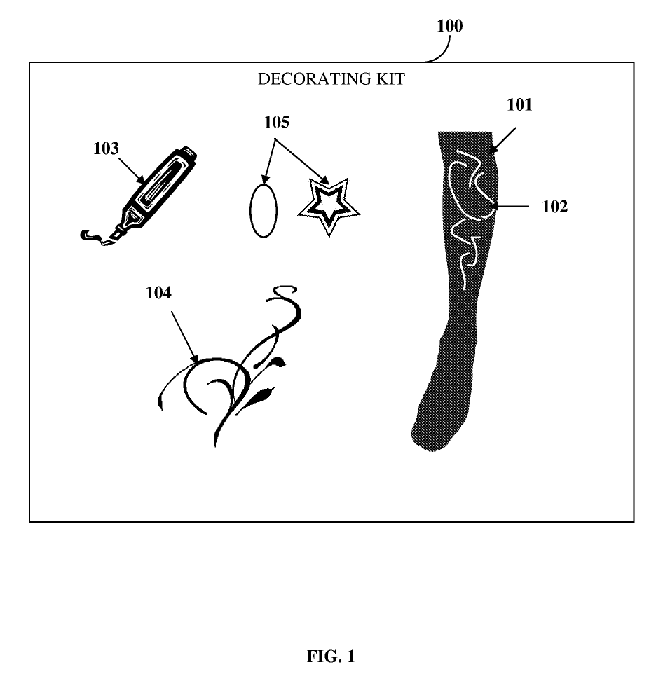

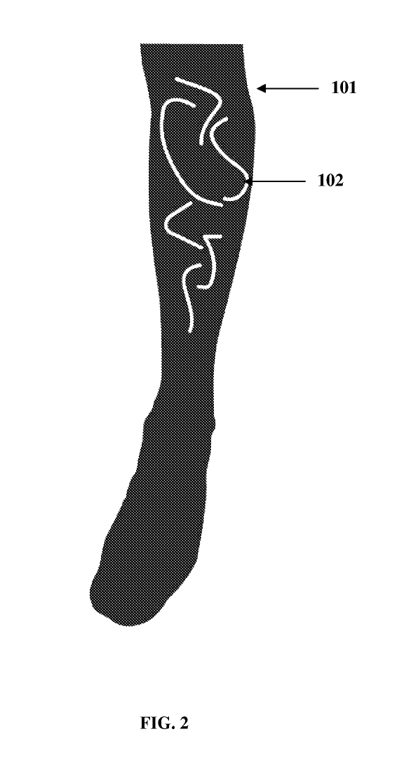

FIG. 1 exemplarily illustrates a decorating kit 100 for decorating an article 101. The decorating kit 100 disclosed herein comprises an article 101 having a material with a color that conceals color applied to the article 101, one or more designs 102 applied on the article 101, and one or more coloring markers 103 for coloring the designs 102 and 104. As used herein, the term “article” 101 refers, for example, to an article 101 of clothing, an accessory, a pet product, etc., with designs 102 embedded or applied on the article 101. The article 101 shown by way of an example in FIGS. 1-2 is a clothing article, for example, a pair of socks, stockings, pantyhose, scarves, etc. The accessory is, for example, a handbag, a shoe, a belt, a hat, etc. The pet product is, for example, a collar, a saddle, etc. The material of the article 101 has a color that conceals color applied to the article 101 by a coloring marker 103. The color of the article 101 does not show colors that inadvertently extend beyond the designs 102 onto the article 101. In an embodiment, the color of the article 101 is a light absorbing color or dark color, for example, a black color that conceals colors that over-mark and extend beyond the colors applied to the designs 102. In another embodiment, the color of the article 101 is a light color, which does not show lighter colors applied to the designs 102 on the article 101 using the coloring markers 103.

The material of the article 101 is configured to conform to a shape of the article 101. For example, FIG. 1 illustrates a clothing article 101, such as a black colored sock, with white or silver colored designs 102 applied to the black colored sock 101 in the decorating kit 100. When a user uses one or more of the coloring markers 103 to color the designs 102 applied on the article 101, the colors from the coloring markers 103 that inadvertently over-mark and extend beyond the designs 102 onto the article 101 are concealed by the color of the article 101 and are therefore not visible on the article 101, thereby allowing the user to impart the desired colors on the designs 102 without any over-mark of the colors showing on the material of the article 101. For purposes of illustration, the detailed description refers to the article 101 being a sock; however, the article 101 in the decorating kit 100 disclosed herein may be extended to include stockings, pantyhose, scarves, pet products, accessories, and other articles.

In an embodiment, the color of the article 101 is of a darker color than the colors applied on the designs 102 so that the colors that inadvertently extend beyond the designs 102 are not visible on the darker colored material of the article 101. For example, if a design 102 applied on the article 101 is to be colored a light green or a teal blue color, the color of the article 101 is dark blue.

In an embodiment, cut-away or peelable designs 104 that are attachable to the article 101 are provided in the decorating kit 100 disclosed herein. The decorating kit 100 disclosed herein provides materials, for example, paper, cardboard, fabrics, sticker material, etc. from which the designs 104 can be cut out or peeled and attached onto the article 101. In an embodiment, the decorating kit 100 disclosed herein provides, for example, an adhesive, a fastener, etc., for attaching the cut-away or peelable designs 104 to the article 101.

Coloring markers 103 for coloring the designs 102 are also provided in the decorating kit 100 disclosed herein. A user applies colors from the coloring markers 103 on the designs 102 for coloring the designs 102 applied on the article 101. The coloring markers 103 are of different colors and may have one or more tips. Each of the coloring markers 103 contain a color dissolved or suspended in a solvent, for example, alcohol. Each of the coloring markers 103 produces a washable color or a permanent color on the designs 102 applied on the article 101. In an example, the coloring markers 103 are multiple double tipped calligraphy markers. A user uses one or more of the double tipped calligraphy markers to write or draw on the designs 102 applied or marked on the surface of the article 101.

In an embodiment, the article 101 is made of a material from which the colors that inadvertently extend beyond the designs 102 onto the article 101 during coloring can be readily erased or wiped off the article 101, for example, by the application of a synthetic removable coating such as a silicone coating on the article 101 before the designs 102 are embedded or applied on the article 101. In this embodiment, the article 101 is coated with a layer of synthetic oil or a silicone spray; the designs 102 are then embedded or applied onto the article 101. The use of silicone or other coating applied on the material of the article 101 allows the designs 102 to be marked by colors that are visible and not concealed on the material of the article 101. Colors applied to the designs 102 that extend beyond the designs 102 onto the material of the article 101 are wiped off or washed out, for example, by a detergent wash.

In another embodiment, the decorating kit 100 disclosed herein further comprises decorative elements 105, for example, ornaments, beads, glitter, etc. that can be attached to the designs 102 and the article 101 for decorating the designs 102 on the article 101 and the article 101 itself. The decorative elements 105 attached to the article 101 can be colored using the coloring markers 103. The decorative elements 105 provide a means for further decorating the article 101. In an example, the user decorates the article 101 by attaching decorative elements 105, for example, beads and stars onto the article 101 using an adhesive and thereafter coloring the decorative elements 105 with the coloring markers 103.

FIG. 2 exemplarily illustrates an article 101 with designs 102 applied on the article 101. The designs 102 applied on the article 101 are of different shapes and sizes. For example, a streaked design is applied on a black colored sock article 101 as exemplarily illustrated in FIG. 2. In an embodiment, the designs 102 are screened on the article 101, for example, by screen printing. Screen printing uses a woven mesh to support a screen stencil, for example, an ink-blocking stencil. The screen stencil forms open areas of mesh that transfer ink as sharp-edged designs 102 onto the surface of the article 101. A roller is moved across the screen stencil, forcing or pumping ink past the threads of the woven mesh in the open areas. Materials used for screen printing are, for example, made of plastisol, water based inks, polyvinyl chloride (PVC)/pthalate free discharge inks, flocking, glitter/shimmer, metallic inks, expanding ink, caviar beads, four color process, gloss, nylobond, mirrored silver, suede ink, etc. Screen-printing presses that can produce designs 102 on the article 101 comprise, for example, fabric flatbed presses, cylinder presses, rotary presses, etc. In another embodiment, the designs 102 are applied onto the article 101, for example, by heat transfer printing. In the heat transfer printing technique, the designs 102 are transferred to the article 101 by pressing a carrier paper that houses ink and the designs 102 onto the article 101 and applying heat.

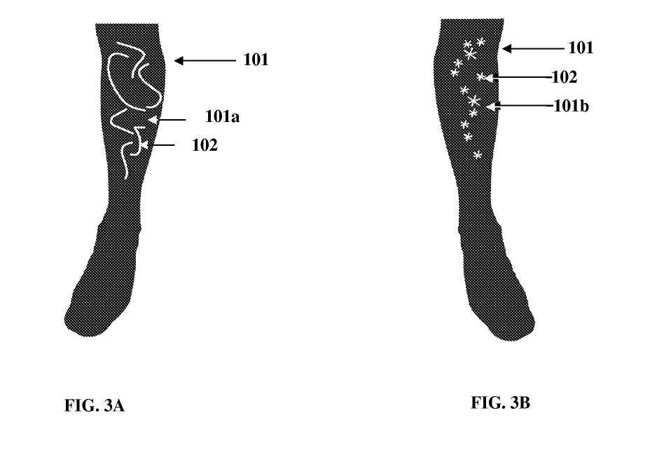

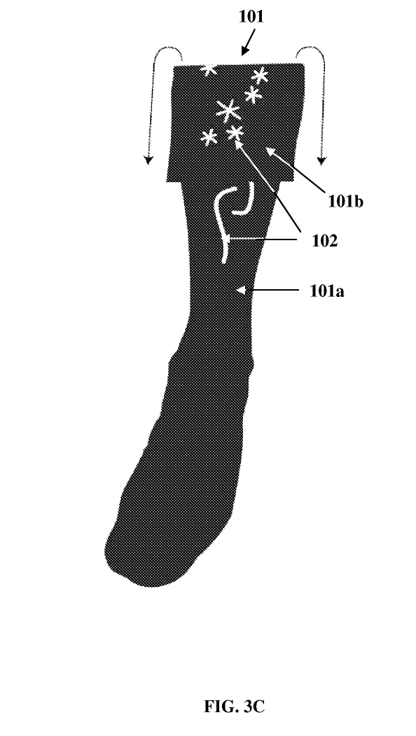

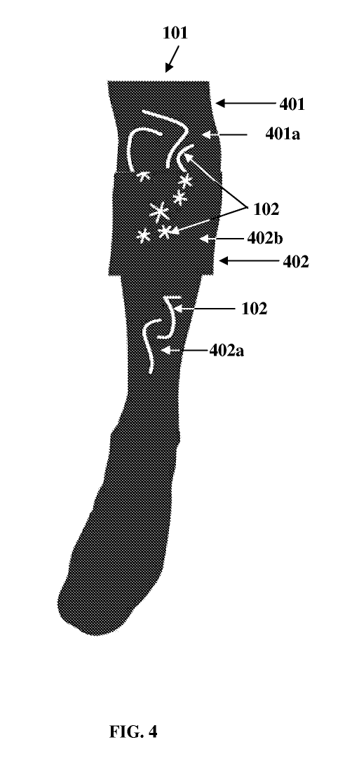

FIG. 3A exemplarily illustrates an article 101 with designs 102 applied on an outer surface 101a of the article 101. FIG. 3B exemplarily illustrates the article 101 folded inside out to show designs 102 applied on an inner surface 101b of the article 101. In an embodiment, the designs 102 are applied on the inner surface 101b and the outer surface 101a of the article 101 to render the article 101 decoratable on both the inner surface 101b and the outer surface 101a of the article 101. Consider an example where a starred design is applied on the inner surface 101b of the article 101 and a streaked design is applied on the outer surface 101a of the article 101, for example, a nylon sock. The user colors the starred design applied on the inner surface 101b of the sock with, for example, a light green color. The user colors the streaked design on the outer surface 101a of the sock with, for example, a tan color. The user can then wear the sock on the inner surface 101b or on the outer surface 101a, to show a design 102 colored with the user's preferences on either surface 101a or 101b of the article 101. In an example, a user wears the black colored sock article 101 to display the designs 102, for example, curved lines or streaks, on the outer surface 101a of the black colored sock article 101. The user can also wear the black colored sock article 101 inside out to display the designs 102 on the inner surface 101b of the black colored sock article 101.

In another embodiment, the user can configure the article 101 in a style that reveals the designs 102 on the inner surface 101b and the outer surface 101a of the article 101. For example, the user can fold the upper portion of the black colored sock article 101 outwardly as exemplarily illustrated in FIG. 3C to reveal the designs 102 on the inner surface 101b along with the designs 102 on the outer surface 101a of the article 101. FIG. 3C exemplarily illustrates the article 101 configured to display the designs 102 on the inner surface 101b and the outer surface 101a of the article 101. Selective configuration of the article 101 allows the user to expose the designs 102 colored with the color preferences of the user, applied on the inner surface 101b and/or the outer surface 101a of the article 101, without the applied colors that extend beyond the designs 102, visible on the material of the article 101.

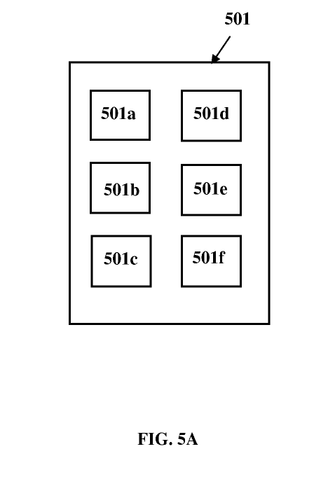

FIG. 4 exemplarily illustrates an embodiment where an article 101 comprises configurable layers 401 and 402 that are selectively configured to display the designs 102 colored with the color preferences of the user on the inner surface 402b and the outer surface 401a or 402a of the article 101, without the applied colors that extend beyond the designs 102, visible on the material of the article 101. In this embodiment, the article 101 provided in the decorating kit 100 disclosed herein comprises one or more configurable layers 401 and 402 comprising multiple designs 102. As used herein, “configurable layers” refers to layers 401 and 402 of the article 101 that can be configured by a user into any shape and style to reveal and display different designs 102 on the inner surface 402b and the outer surface 401a or 402a of the article 101. The configurable layers 401 and 402 enable the user to expose and color the designs 102 applied on the configurable layers 401 and 402 in multiple styles and colors. Consider an example where the article 101 comprises two configurable layers namely an inner layer 401 and an outer layer 402. The outer layer 402 comprises designs 102 applied on both the inner surface 402b and the outer surface 402a of the outer layer 402. The inner layer 401 comprises designs 102 applied on the outer surface 401a of the inner layer 401. The user configures the article 101 to selectively expose the layers 401 and 402, revealing different designs 102 colored with the color preferences of the user on the layers 401 and 402, thereby enabling the article 101 with the colored designs 102 to be decorated in multiple styles, without the applied colors that extend beyond the designs 102, visible on the material of the article 101.

Consider an example of a two-layered black colored sock article 101 as exemplarily illustrated in FIG. 4. The outer layer 402 encloses the inner layer 401. The outer surface 401a of the inner layer 401 and the outer surface 402a of the outer layer 402 have a streaked design of curved lines. The inner surface 402b of the outer layer 402 has a starred design with stars. The outer layer 402 can be configured, that is, the outer layer 402 can be folded outwardly to reveal a part of its inner surface 402b comprising the starred design and a part of the outer surface 401a of the inner layer 401 comprising the streaked design. If a user wants both the streaked design and the starred design to be displayed alternately, the user folds the outer layer 402 of the black colored sock article 101 downwards to reveal a part of the streaked design on the outer surface 401a of the inner layer 401, a part of the inner surface 402b of the outer layer 402 which has the starred design, and the rest of the outer surface 402a of the outer layer 402 which has the streaked design. The user therefore creates a style that alternately displays the streaked design and the starred design as exemplarily illustrated in FIG. 4. This created style reveals a selective combination of two designs 102. When the user wants only the streaked design to show on the black colored sock article 101, the user unfolds the outer layer 402 of the black colored sock article 101 upwards such that the outer layer 402 fully encloses the inner layer 401 of the black colored sock article 101, thereby revealing only the streaked design on the outer surface 402a of the black colored sock article 101 colored with the color preferences of the user without the applied colors that extend beyond the designs 102, visible on the material of the black colored sock article 101.

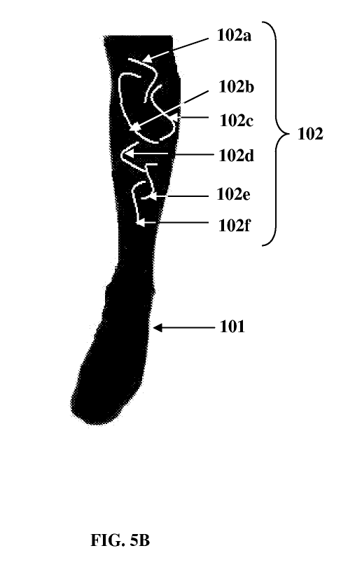

FIGS. 5A-5B exemplarily illustrate an embodiment of the decorating kit 100 comprising a color chart 501 with color codes 501a, 501b, 501c, 501d, 501e, and 501f for aiding a user to select colors for coloring designs 102a, 102b, 102c, 102d, 102e, and 102f applied on the article 101. The color chart 501 as exemplarily illustrated in FIG. 5A indicates the colors to be applied on the designs 102 applied on the article 101. FIG. 5B exemplarily illustrates an article 101 with multiple designs 102a, 102b, 102c, 102d, 102e, and 102f applied on the article 101. The color chart 501 comprises color codes 501a, 501b, 501c, 501d, 501e, and 501f that correspond to the colors to be applied on the designs 102a, 102b, 102c, 102d, 102e, and 102f respectively on the article 101. The color codes 501a, 501b, 501c, 501d, 501e, and 501f indicate modes of changing an appearance of the designs 102a, 102b, 102c, 102d, 102e, and 102f applied on the article 101 or an object enclosed by the article 101. Consider an example where the color codes 501a, 501b, 501c, 501d, 501e, and 501f in the color chart 501 exemplarily illustrated in FIG. 5A correspond to the colors blue, white, orange, red, indigo, and yellow respectively, to be applied on the designs 102a, 102b, 102c, 102d, 102e, and 102f respectively on the article 101. The appearance of an object enclosed by the article 101 changes when the designs 102a, 102b, 102c, 102d, 102e, and 102f applied on the article 101 are colored as indicated by the color codes 501a, 501b, 501c, 501d, 501e, and 501f on the color chart 501. Consider an example, where the article 101 is a sock. The object is, for example, the user's leg enclosed by the sock. The color chart 501 indicates the color code 501a, 501b, 501c, 501d, 501e or 501f which when applied to the designs 102a, 102b, 102c, 102d, 102e, and 102f on the sock, gives an object, for example, the calf muscles of the user a slimming appearance or a fuller appearance.

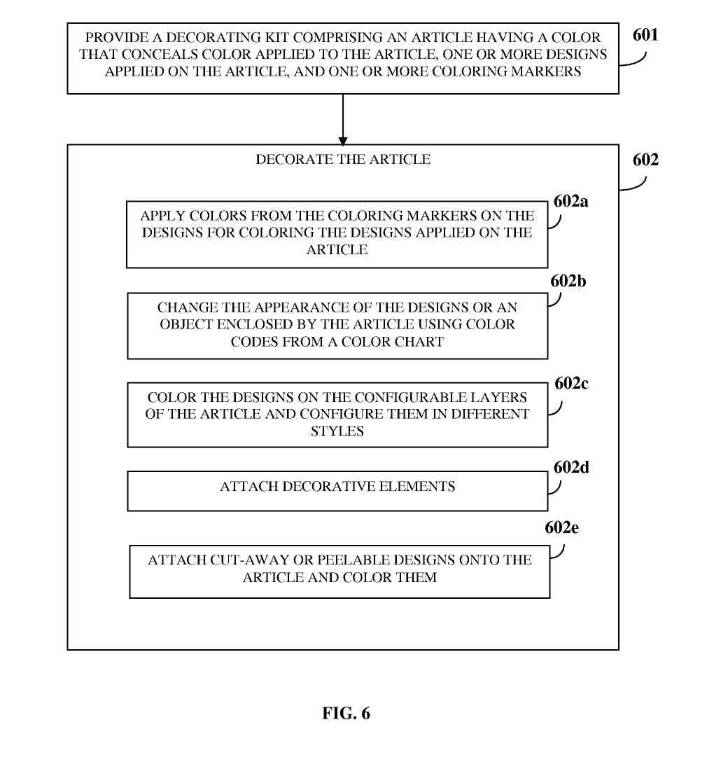

FIG. 6 exemplarily illustrates a method for decorating an article 101. A decorating kit 100 comprising an article 101 having a color that conceals color applied to the article 101, one or more designs 102 applied on the article 101, and one or more coloring markers 103 as disclosed in the detailed description of FIG. 1 is provided 601. The user decorates 602 the article 101 as follows: The user applies 602a colors from the coloring markers 103 on the designs 102 for coloring the designs 102 applied on the article 101 with the user's color preferences. The user changes 602b the appearance of the designs 102, or an object enclosed by the article 101 using the color codes 501a, 501b, 501c, 501d, 501e, and 501f from a color chart 501 as exemplarily illustrated in FIG. 5. The user colors 602c multiple designs 102 on the configurable layers 401 and 402 of the article 101 with multiple colors and configures them in different styles as exemplarily illustrated in FIG. 4. The user can then attach 602d decorative elements 105, for example, ornaments, beads, glitter, etc. on the article 101 and color the attached decorative elements 105 with the user's color preferences. The user can further decorate the article 101 by attaching 602e cut-away or peelable designs 104 onto the article 101 and coloring them with the user's color preferences. The user can therefore color the designs 102 and 104 on the article 101 using the coloring markers 103 without the colors that over-mark or extend beyond the designs 102 and 104, visible on the material of the article 101, as the article 101 conceals the colors that extend beyond the designs 102 and 104 onto the article 101.

The foregoing examples have been provided merely for the purpose of explanation and are in no way to be construed as limiting of the invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A decorating kit comprising:
an article having a color that conceals color applied to said article;
one or more designs applied on said article; and
one or more coloring markers for coloring said one or more designs, wherein colors from said one or more coloring markers that inadvertently extend beyond said one or more designs onto said article are not visible on said article;
whereby a user can color said one or more designs on said article using said one or more coloring markers, without said colors that over-mark said one or more designs, visible on said article.

2. The decorating kit of claim 1, wherein said article is one or more of clothing, an accessory, and a pet product.

3. The decorating kit of claim 1, wherein said color of said article is a light absorbing color.

4. The decorating kit of claim 1, wherein said color of said article is a color on which said colors that inadvertently extend beyond said one or more designs onto said article are not visible on said article.

5. The decorating kit of claim 1, wherein said one or more designs are screened onto said article.

6. The decorating kit of claim 1, wherein said one or more designs are applied onto said article by one of a screen printing technique and a heat transfer printing technique.

7. The decorating kit of claim 1, wherein said one or more designs are applied on an inner surface and an outer surface of said article to render said article decoratable on said inner surface and said outer surface of said article.

8. The decorating kit of claim 1, wherein said one or more designs are one of cut-away designs and peelable designs that are attachable to said article.

9. The decorating kit of claim 1, further comprising a color chart with color codes for aiding said user to select colors for coloring said one or more designs applied on said article, wherein said color codes indicate modes of changing an appearance of said one or more designs applied on said article and an object enclosed by said article.

10. The decorating kit of claim 1, wherein each of said one or more coloring markers contains one of a color dissolved in a solvent and a color suspended in a solvent.

11. The decorating kit of claim 1, wherein each of said one or more coloring markers produces one of a washable color and a permanent color on said one or more designs applied on said article.

12. The decorating kit of claim 1, wherein a material of said article allows one of erasing and wiping off said colors that extend beyond said one or more designs onto said article during said coloring.

13. The decorating kit of claim 1, wherein said article comprises one or more configurable layers comprising a plurality of said one or more designs, wherein said one or more configurable layers enable said user to expose and color said one or more designs applied on said one or more configurable layers in a plurality of styles and colors.

14. The decorating kit of claim 1, further comprising a plurality of decorative elements attachable to said one or more designs and said article for decorating said one or more designs and said article.

15. A method for decorating an article, comprising:
providing a decorating kit comprising:
said article having a color that conceals color applied to said article;
said one or more designs applied on said article; and
one or more coloring markers; and
applying colors from said one or more coloring markers on said one or more designs for coloring said one or more designs applied on said article, wherein said colors from said one or more coloring markers that inadvertently extend beyond said one or more designs onto said article are not visible on said article;
whereby a user can color said one or more designs on said article using said one or more coloring markers, without said colors that over-mark said one or more designs, visible on said article.

16. The method of claim 15, further comprising providing a color chart with color codes in said decorating kit for aiding said user to select colors for said coloring said one or more designs applied on said article, wherein said color codes indicate modes of changing an appearance of said one or more designs applied on said article and an object enclosed by said article.

17. The method of claim 15, further comprising providing one or more cut-away designs, peelable designs, and decorative elements in said decorating kit for decorating said one or more designs and said article.

18. The method of claim 15, wherein said one or more designs are applied onto said article by one of a screen printing technique and a heat transfer printing technique.

19. The method of claim 15, wherein said article comprises one or more configurable layers comprising a plurality of said one or more designs, wherein said user exposes and colors said one or more designs applied on said one or more configurable layers in a plurality of styles and colors.

20. A decoratable article comprising:
a material having a light absorbing color that conceals color applied to said article, wherein said color of said material does not show colors applied to said material; and
one or more designs applied on said material, wherein said material with said one or more designs is configured to conform to a shape of an article;
whereby said user can color said one or more designs on said article, wherein colors that inadvertently extend beyond said one or more designs onto said material of said article are not visible on said article.
